(19) United States
(12) Patent Application Publication
(10) Pub. No.: US 2025/0253507 A1
(43) Pub. Date: Aug. 7, 2025

(54) ELECTRODE STACK AND BATTERY

(71) Applicant: TOYOTA JIDOSHA KABUSHIKI KAISHA, Toyota-shi (JP)

(72) Inventor: Ryuto SAKAMOTO, Okazaki-shi (JP)

(73) Assignee: TOYOTA JIDOSHA KABUSHIKI KAISHA, Toyota-shi (JP)

(21) Appl. No.: 19/007,790

(22) Filed: Jan. 2, 2025

(30) Foreign Application Priority Data
Feb. 5, 2024 (JP) 2024-015927

(51) Int. Cl. H01M 50/586; H01M 4/70; H01M 10/0525; H01M 10/0562; H01M 10/0585; H01M 50/105

(52) U.S. Cl. CPC H01M 50/586; H01M 4/70; H01M 10/0525; H01M 10/0562; H01M 10/0585; H01M 50/105; H01M 2300/0068

(57) ABSTRACT

The present disclosure provides an electrode stack that is resistant to peeling of anchoring members disposed on side sections thereof, as well as a battery comprising the electrode stack. As exemplified in FIG. 1, in the electrode stack 10 of the disclosure, a positive electrode collector layer 11, a positive electrode active material layer 12, an electrolyte layer 13, a negative electrode active material layer 14 and a negative electrode collector layer 15 are stacked in that order. In the electrode stack 10 of the disclosure, anchoring members 20 comprising a curable resin are disposed on side sections thereof. Among the layers of the electrode stack 10 of the disclosure, the positive electrode collector layer 11 and/or negative electrode collector layer 12 each have recesses 10a on the sides where the anchoring members 20 are disposed, with parts of the anchoring members 20 intruding into the recesses 10a.

### FIELD

The present disclosure relates to an electrode stack and a battery.

### BACKGROUND

In a battery such as a lithium ion secondary battery it is common to employ an electrode stack comprising a positive electrode collector layer, a positive electrode active material layer, an electrolyte layer, a negative electrode active material layer and a negative electrode collector layer. In order to prevent shifting between the layers in such electrode stacks, techniques have been developed in which an anchoring member comprising a curable resin is provided on the side sections of the electrode stack.

For example, PTL 1 discloses an all-solid-state battery comprising an electrode body (electrode stack), which is provided with a positive electrode collector layer, a positive electrode mixture layer (positive electrode active material layer), a solid electrolyte layer, a negative electrode mixture layer (negative electrode active material layer) and a negative electrode collector layer, and an exterior body enclosing the electrode body, wherein an electrically insulating protective member (anchoring member) is disposed on a side of the stack, the protective member having a groove extending in the direction running along the surface of the stack.

PTL 2 discloses a method of producing an all-solid-state battery comprising a flat-shaped stacked electrode body (electrode stack), an exterior body made of a laminate film housing the stacked electrode body, and a protective member (anchoring member) made of a resin formed on a side surface of the stacked electrode body.

### CITATION LIST

### Patent Literature

[PTL 1] Japanese Unexamined Patent Publication No. 2023-071379
[PTL 2] Japanese Unexamined Patent Publication No. 2021-114374

### SUMMARY

### Technical Problem

An anchoring member comprising a curable resin may peel from the electrode stack, making it unable to adequately exhibit its function as an anchoring member.

It is an object of the present disclosure to provide an electrode stack that is resistant to peeling of anchoring members disposed on side sections thereof, as well as a battery comprising the electrode stack.

### Solution to Problem

The present inventors have found that this object can be achieved by the following means.

### <Aspect 1>

An electrode stack in which a positive electrode collector layer, a positive electrode active material layer, an electrolyte layer, a negative electrode active material layer and a negative electrode collector layer are stacked in that order, wherein anchoring members containing the curable resin are disposed on side sections thereof, and wherein among the layers of the electrode stack, the positive electrode collector layer and/or the negative electrode collector layer each have recesses on the sides where the anchoring members are disposed, with parts of the anchoring members intruding into the recesses.

### <Aspect 2>

The electrode stack according to aspect 1, wherein only the positive electrode collector layer and/or the negative electrode collector layer has the recesses.

### <Aspect 3>

The electrode stack according to aspect 2, wherein the positive electrode collector layer has the recesses.

### <Aspect 4>

The electrode stack according to aspect 3, wherein the outermost positive electrode collector layer has the recesses.

### <Aspect 5>

The electrode stack according to any one of aspects 1 to 4, wherein the depth of the recesses is 1 mm or more and 3 mm or less.

### <Aspect 6>

A battery comprising:
one or more electrode stacks according to any one of aspects 1 to 5, and
a laminate film sealing the electrode stack.

### Advantageous Effects of Invention

According to the present disclosure it is possible to provide an electrode stack that is resistant to peeling of anchoring members disposed on side sections thereof, as well as a battery comprising the electrode stack.

### BRIEF DESCRIPTION OF DRAWINGS

FIG. 1 is a simplified perspective view showing an example of an electrode stack of the disclosure.

FIG. 2 is a schematic plan view showing an example of a positive electrode collector layer with recesses, in an electrode stack of the disclosure.

FIG. 3A is a schematic diagram showing examples of recess shapes.

FIG. 3B is a schematic diagram showing examples of recess shapes.

FIG. 3C is a schematic diagram showing examples of recess shapes.

FIG. 3D is a schematic diagram showing examples of recess shapes.

FIG. 3E is a schematic diagram showing examples of recess shapes.

FIG. 3F is a schematic diagram showing examples of recess shapes.

FIG. 4 is a simplified perspective view showing an example of a battery of the disclosure.

FIG. 5 is a simplified perspective view showing an example of an electrode stack according to a Comparative Example.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships relating to the disclosure do not reflect actual dimensional relationships.

### <Electrode Stack>

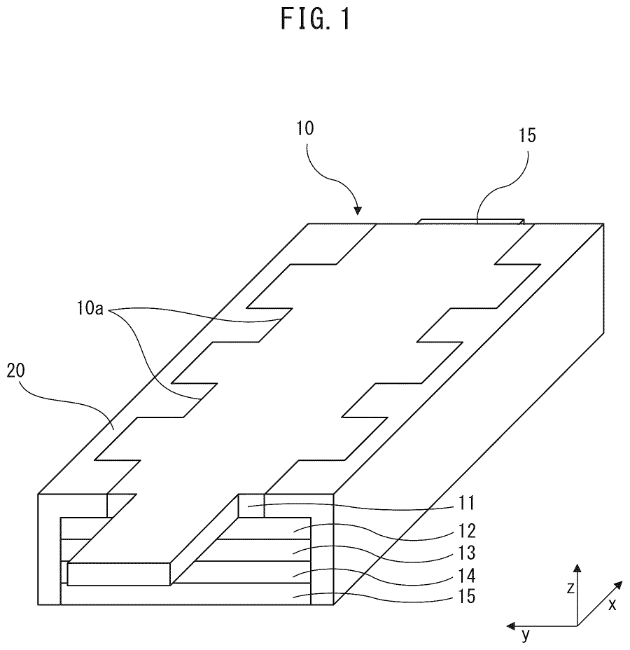

As exemplified in FIG. 1, in the electrode stack 10 of the disclosure, a positive electrode collector layer 11, a positive electrode active material layer 12, an electrolyte layer 13, a negative electrode active material layer 14 and a negative electrode collector layer 15 are stacked in that order. In the electrode stack 10 of the disclosure, anchoring members 20 comprising a curable resin are disposed on side sections thereof. Among the layers of the electrode stack 10 of the disclosure, the positive electrode collector layer 11 and/or negative electrode collector layer 12 each have recesses 10a on the sides where the anchoring members 20 are disposed, with parts of the anchoring members 20 intruding into the recesses 10a.

The present inventors considered that one of the reasons for peeling of a curable resin-containing anchoring member from an electrode stack is the stress generated along with cure shrinkage of the curable resin.

In this regard, the present inventors found that if, among the layers of the electrode stack, at least the positive electrode collector layer and/or negative electrode collector layer have recesses on the sides where the anchoring members are disposed and parts of the anchoring members are intruding into the recesses, then it is possible to inhibit peeling of the anchoring members comprising the curable resin from the electrode stack. Without being constrained by any particular theory, the reason for this is believed to be that such a construction makes it possible to increase the contact area between the anchoring members and the layers having recesses on the sides, such as the positive electrode collector layer and/or negative electrode collector layer.

The term “electrode stack” as used herein means a stack that forms a unit cell. A “unit cell” may be a stack comprising a positive electrode collector layer, a positive electrode active material layer, a solid electrolyte layer (separator layer), a negative electrode active material layer and a negative electrode collector layer.

For the purpose of the disclosure, “surface” refers to a surface forming a wide laminar area on each layer composing the electrode stack and the electrode stack itself, while “side surface” refers to a side forming part of the thickness between surfaces. Therefore the “side sections”, for the purpose of the disclosure, are the sections of the electrode stack forming the side surfaces.

As exemplified in FIG. 1, the electrode stack 10 of the disclosure has a positive electrode collector layer 11, a positive electrode active material layer 12, an electrolyte layer 13, a negative electrode active material layer 14 and a negative electrode collector layer 15, stacked in that order.

In the electrode stack 10 of the disclosure, anchoring members 20 comprising a curable resin are disposed on side sections. For example, the anchoring members may be bonded at the side sections by curing of a curable resin.

It is sufficient if the anchoring members are disposed on at least one side section, and they may be disposed on a pair of opposite side sections. If the anchoring members are disposed on a pair of opposite side sections, this will improve the effect of preventing shifting between the layers of the electrode stack by the anchoring members, and help prevent short circuiting caused by inclusion of conductive contaminants, or damage due to external impact.

The thickness of the anchoring members is not particularly restricted and may be 0.1 mm or more, 0.5 mm or more or 1.0 mm or more, and 3.0 mm or smaller, 2.5 mm or smaller or 2.0 mm or smaller. The thickness of the anchoring members is the length from the edge of each anchoring member up to the part of the electrode stack where the recesses are not formed.

The curable resin is not particularly restricted, and for example, it may be a photocuring resin such as an UV curing resin or electron beam-curing resin, or a thermosetting resin. The curable resin may be a radical-polymerizing resin or cationic polymerizable resin, or a combination thereof. Specifically, it may be an acrylate-based UV curing resin.

The Young's modulus of the anchoring members can be adjusted by controlling the coating amount and curing degree of the curable resin. The Young's modulus of the anchoring members is not particularly restricted and may be 400 N/mm² to 550 N/mm², for example.

Of the layers of the electrode stack 10 of the disclosure, the positive electrode collector layer 11 and/or negative electrode collector layer 15 each have recesses 10a on the sides where the anchoring members are disposed, with parts of the anchoring members 20 intruding into the recesses 10a. In this regard, the layers forming the electrode stack other than the positive electrode collector layer and negative electrode collector layer may also have recesses 10a. The electrode stack 10 of the disclosure may also include a positive electrode collector layer and a negative electrode collector layer without recesses.

Alternatively, only the positive electrode collector layer 11 and/or negative electrode collector layer 15 of the electrode stack 10 of the disclosure may have recesses 10a. In other words, the positive electrode collector layer 11 and/or negative electrode collector layer 15 of the electrode stack 10 of the disclosure have recesses 10a, but the positive electrode active material layer 12, electrolyte layer 13 and negative electrode active material layer 14 do not need to have recesses. With such a construction, the resistance of the battery comprising the electrode stack can be lowered while maintaining adhesion between the electrode stack and anchoring members.

Alternatively, only the positive electrode collector layer 11 of the electrode stack 10 of the disclosure may have recesses 10a. When the area of the surface of the negative electrode collector layer is smaller than the area of the surface of the positive electrode collector layer in an electrode stack, this generally results in formation of dendrites on the negative electrode active material layer. If the positive electrode collector layer has recesses, then it will be easier to make the area of the surface of the positive electrode collector layer smaller than the area of the surface of the negative electrode collector layer, making it possible to reduce formation of dendrites while maintaining adhesion between the electrode stack and the anchoring members.

The outermost positive electrode collector layer 11 of the electrode stack 10 of the disclosure may have recesses 10a. For example, when a battery of the disclosure as described below has a plurality of electrode stacks, the positive electrode collector layers may be disposed as inner layers of the electrode stacks. Even when the recesses are formed at the sides on the positive electrode collector layers disposed as inner layers in this manner, the anchoring members may not fully intrude into the recesses. If the outermost positive electrode collector layer has recesses, then the anchoring members can appropriately intrude into the recesses, helping to effectively reduce peeling of the anchoring members from the electrode stack.

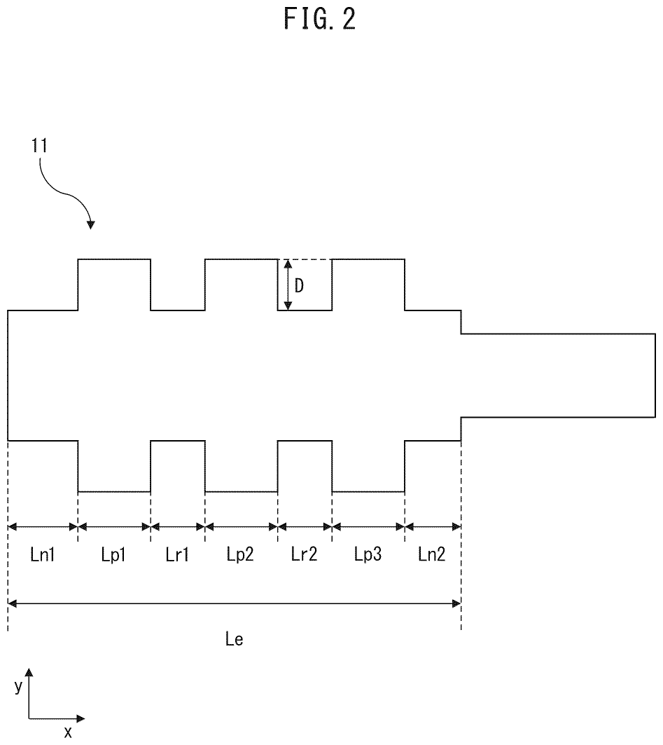

The shape of the layer with recesses is not particularly restricted. For example, the shape of the layer with recesses may be the shape exemplified in FIG. 2.

In FIG. 2, D represents the depth of the recesses.

For the electrode stack 10 of the disclosure, the depth D of the recesses may be 1 mm or more and 3 mm or less. With such a construction, the resistance of the battery comprising the electrode stack can be lowered while maintaining adhesion between the electrode stack and anchoring members. The depth D may be appropriately designed according to the length in the y-direction of the layer with recesses, for example.

In FIG. 2, each L represents a length of a part of the positive electrode collector layer. Specifically, Lr, Lp, Ln and Ln represent the following lengths:
Lr=recess length
Lp=length of part of recess between both edges (also referred to as “protrusion” for convenience),
Ln=length of non-protrusion part of recess,
Le=length of side section extending in x-direction of electrode stack (Lr+Lp+Ln)

The length Lr and length Lp can be appropriately designed according to the properties of the curable resin used in the anchoring members and the thicknesses of the anchoring members. For multiple recesses, the multiple lengths Lr may be the same or different. Multiple lengths Lp may also be the same or different.

Lr may be 1 mm or more, 5 mm or more or 10 mm or more, and 20 mm or less, 15 mm or less or 10 mm or less, for example.

Lp may be 60 mm or more, 70 mm or more or 80 mm or more, and 140 mm or less, 130 mm or less or 120 mm or less, for example.

Ln may be 1 mm or more, 5 mm or more or 10 mm or more, and 20 mm or less, 15 mm or less or 10 mm or less, for example.

Le may be 300 mm or more, 350 mm or more or 400 mm or more, and 500 mm or less, 450 mm or less or 400 mm or less, for example.

From the viewpoint of effectively inhibiting peeling of the anchoring members from the electrode stack, the ratio Le/Lpmax (maximum Lp) may be 1.6 or more, 1.7 or more, 1.8 or more or 1.9 or more, and 4.0 or more, 3.5 or more, 3.3 or more, 3.1 or more or 3.0 or more.

The area S of the recesses may be 10 mm² or more and 30 mm² or less, for example. The area S may be appropriately designed according to the total area of the layer with recesses.

The number of recesses may be one or more than one. If the number of recesses is more than one, the number may be 2 or more or 3 or more, and 5 or less, 4 or less, 3 or less or 2 or less.

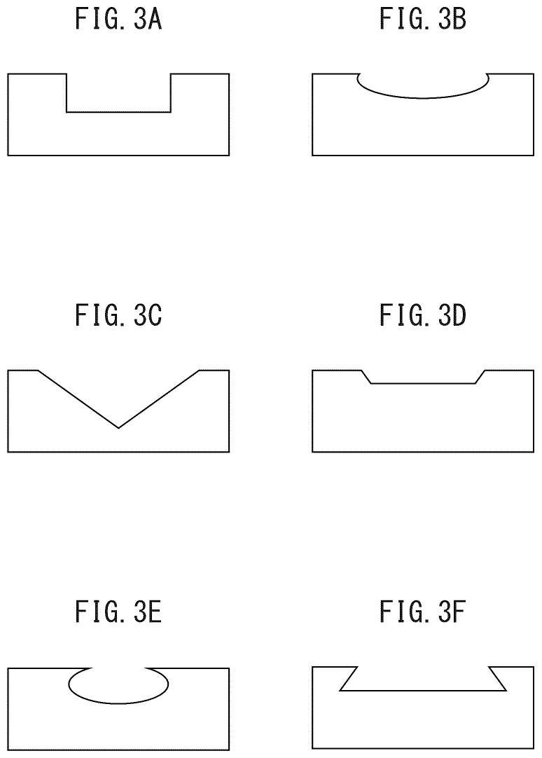

In FIGS. 1 and 2 the shapes of the recesses are quadrilateral, but there is no limitation to such shapes. For example, as shown in FIGS. 3A to 3F, the shapes of the recesses may be elliptical (see FIGS. 3B and 3E), triangular (see FIG. 3C) or trapezoid (see FIGS. 3D and 3F).

The method of forming the recesses is not particularly restricted, and for example, the sides of the layer where the recesses are to be formed may be cut to the desired shapes and sizes.

### <Battery>

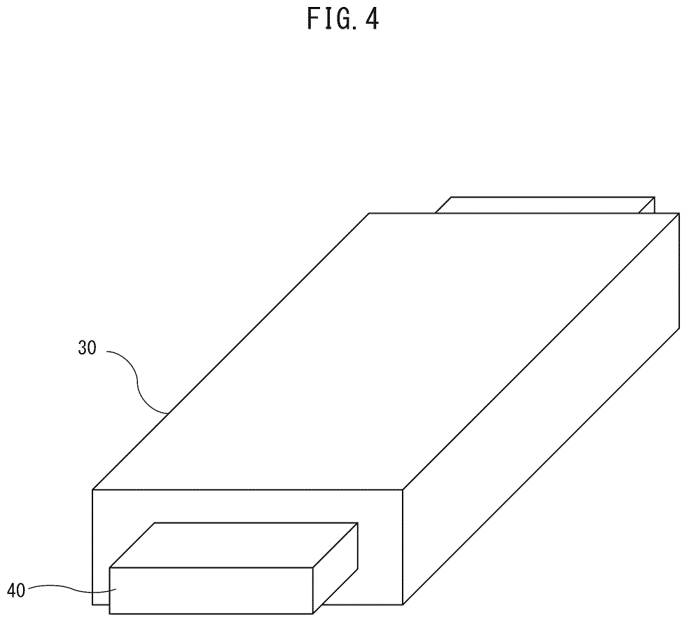

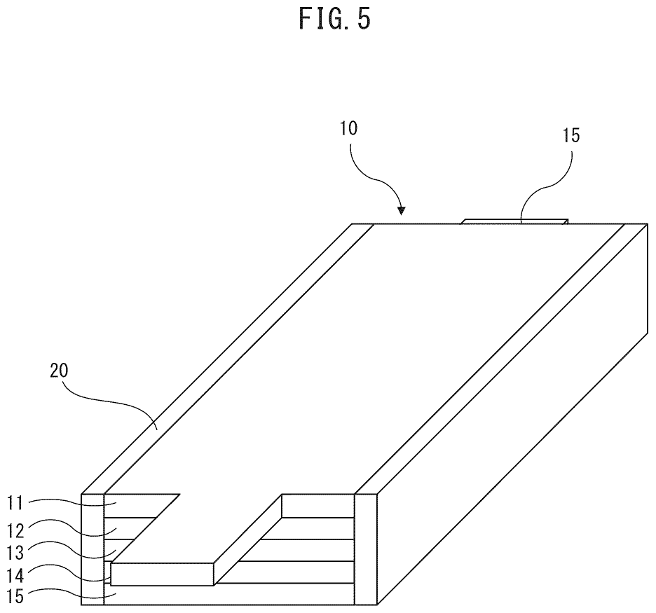

As exemplified in FIG. 4, the battery 100 of the disclosure has one or more electrode stacks, and a laminate film 30 that seals the electrode stacks. The battery 100 of the disclosure may also have current collector terminals 40 electrically connected to a current collector foil.

When the battery of the disclosure has a plurality of electrode stacks, it may also include a positive electrode collector layer and a negative electrode collector layer without recesses.

The battery of the disclosure may be a liquid battery or a solid-state battery. The battery of the disclosure is most especially a solid-state battery. Since the electrolyte layer in a solid-state battery is formed using a solid electrolyte, the side surfaces of the electrode stack containing the electrolyte layer are often hard and brittle. The side surfaces of the electrode stack in this case can be effectively protected by providing an anchoring member.

The term “solid-state battery” as used herein refers to a battery using at least a solid electrolyte as the electrolyte, and the solid-state battery may employ a combination of a solid electrolyte and a liquid electrolyte as the electrolyte. The solid-state battery of the disclosure may also be an all-solid-state battery, i.e. a battery employing only a solid electrolyte as the electrolyte.

The battery of the disclosure may be a lithium ion secondary battery, for example. Examples of battery uses include power sources for vehicles such as hybrid vehicles (HEV), plug-in hybrid vehicles (PHEV), electric vehicles (BEV), gasoline automobiles and diesel automobiles. They are most preferably used as drive power supply units for hybrid vehicles (HEV), plug-in hybrid vehicles (PHEV) or electric vehicles (BEV). The battery of the present disclosure may be used as a power source for a traveling body other than a vehicle (such as a railway car, ship or aircraft), or as a power source for an electrical product such as an information processing device.

### <Electrode Stack>

The electrode stack functions as a power generating element in the battery. The electrode stack may be understood by referring to the aforementioned description of the electrode stack of the disclosure.

The shape of the electrode stack is not particularly restricted, and for example, it may have a top side section, a bottom side section opposite the top side section, and four side sections connecting the top side section and bottom side section, as exemplified in FIG. 1. The shape of the top side section is also not particularly restricted, and for example, it may be quadrilateral, such as square, rectangular, rhomboid, trapezoid or parallelogram-shaped. The shape of the top side section may also be a polygonal shape other than quadrilateral, or it may be a shape having curves, such as circular. The shape of the bottom side section is the same shape as the top side section. The shapes of the side sections are also not particularly restricted, and for example, they may be quadrilateral, such as square, rectangular, rhomboid, trapezoid or parallelogram-shaped.

### <Laminate Film>

The laminate film 30 seals the electrode stack 10. The laminate film 30 may also seal the electrode stack 10 together with the current collector terminals 40. Specifically, the laminate film 30 may seal the electrode stack 10 together with the current collector terminals 40, by winding together the electrode stack 10 and current collector terminals 40. The laminate film 30 may be composed of first and second films, in which case the first and second films may seal the electrode stack 10 together with the current collector terminals 40 by sandwiching the electrode stack 10 and current collector terminals 40 above and below in the stacking direction of the electrode stack 10.

The laminate film may have a sealant resin layer, a metal layer and a protective resin layer, in that order along the thickness direction. Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon. The thickness of the sealant resin layer is 40 μm to 100 μm, for example. The thickness of the metal layer may be 30 μm to 60 μm, for example. The thickness of the protective resin layer may be 20 μm to 60 μm, for example. The thickness of the laminate film may be 80 μm to 250 μm, for example.

### <Current Collector Terminals>

The current collector terminals 40 may be electrically connected to the current collector foil. For example, when the anchoring members 20 are disposed on a pair of opposite side sections of the electrode stack 10, the current collector terminals 40 may be disposed on the remaining pair of side sections. The material for the current collector terminals is not particularly restricted so long as it is a material with a current collection function, and for example, it may be the same metal material as the positive electrode collector layer and negative electrode collector layer. The sizes and shapes of the current collector terminals are not particularly restricted.

### <Other Members>

The battery of the disclosure may also comprise an insulating member. The insulating member may be disposed so as to cover the layers other than the positive electrode collector layer at the side sections of the electrode stack where the positive electrode collector layer extends. The insulating member may be a resin or insulating tape, for example.

### <Layers of Electrode Stack>

The materials of the positive electrode collector layer, positive electrode active material layer, electrolyte layer, negative electrode active material layer and negative electrode collector layer composing the electrode stack will now be described.

### <Positive Electrode Collector Layer>

The positive electrode collector layer is not particularly restricted. When forming a lithium ion secondary battery, for example, the material used for the positive electrode collector layer may be, but is not limited to, SUS, nickel, chromium, gold, platinum, aluminum, iron, titanium or zinc, or one of these metals plated or vapor deposited with nickel, chromium or carbon, for example.

The positive electrode collector layer may have its surface covered by a layer comprising a carbon material.

The form of the positive electrode collector layer is not particularly restricted and may be, for example, a foil, sheet or mesh. A foil is preferred among these.

### <Positive Electrode Active Material Layer>

The positive electrode active material layer comprises a positive electrode active material, and may also optionally comprise a solid electrolyte, a conductive aid and a binder.

Publicly known active materials may be used for the positive electrode active material. Examples of positive electrode active materials include, for construction of a lithium ion secondary battery, lithium-containing complex oxides such as lithium cobaltate, lithium nickelate, LiNi_{1/3}Co_{1/3}Mn_{1/3}O₂, lithium manganate or spinel-based lithium compounds. Lithium ferrophosphate (LFP) may be used as an olivine-type positive electrode active material. The positive electrode active material may be in the form of particles, with sizes that are not particularly restricted.

The positive electrode active material may also have a covering layer. The covering layer is a layer comprising a substance that exhibits lithium ion conductivity, has low reactivity with the positive electrode active material or solid electrolyte, and that can maintain the shape of the covering layer without flowing even when contacting the active material or solid electrolyte. Specific examples of materials to form the covering layer include, but are not limited to, LiNbO₃, Li₄Ti₅O₁₂ and Li₃PO₄.

The material of the solid electrolyte is also not particularly restricted, and for construction of a lithium ion secondary battery it may be a sulfide solid electrolyte, for example.

Examples of sulfide solid electrolytes include, but are not limited to, sulfide amorphous solid electrolytes, sulfide crystalline solid electrolytes and argyrodite solid electrolytes. Specific examples of sulfide solid electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₇S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

A sulfide solid electrolyte may be glass or crystallized glass (glass ceramic).

The conductive aid is not particularly restricted. The conductive aid may be, but is not limited to, VGCF (vapor-deposited carbon fiber, acetylene black (AB), Ketjen black (KB), carbon nanotubes (CNT) or carbon nanofibers (CNF).

The binder is also not particularly restricted. For example, the binder may be, but is not limited to, a material such as polyvinylidene fluoride (PVdF), butadiene rubber (BR), styrene-butadiene rubber (SBR), or a combination thereof.

### (Electrolyte Layer)

When the battery of the disclosure is a solid-state battery, the electrolyte layer comprises a solid electrolyte, and it may also optionally comprise a conductive aid and a binder.

The solid electrolyte, a conductive aid and binder may be understood by referring to the description regarding the positive electrode active material layer of the disclosure.

### (Negative Electrode Active Material Layer)

The negative electrode active material layer comprises a negative electrode active material, and may also optionally comprise a solid electrolyte, a conductive aid and a binder.

Publicly known active materials may be used for the negative electrode active material. When constructing a lithium ion secondary battery, for example, it may be silicon or a silicon-based active material such as silicon alloy or silicon oxide as the negative electrode active material; a carbon-based active material such as graphite or hard carbon; an oxide-based active material such as lithium titanate; or lithium metal or lithium alloy. The negative electrode active material may be in the form of particles, with sizes that are not particularly restricted.

The solid electrolyte, conductive aid and binder may be understood by referring to the description regarding the positive electrode active material layer of the disclosure.

### (Negative Electrode Collector Layer)

The negative electrode collector layer is not particularly restricted. When forming a lithium ion battery, for example, the material used for the negative electrode collector layer may be, but is not limited to, copper or copper alloy, and copper that has been plated or vapor deposited with nickel, chromium or carbon.

The form of the negative electrode collector layer is not particularly restricted and may be, for example, a foil, sheet or mesh. A foil is preferred among these.

### EXAMPLES

### Example 1

### <Production of Battery>

### (Preparation of Positive Electrode Active Materials)

Using a tumbling fluidized coating apparatus (product of Powrex Corp.), positive electrode active material particles (particles with Li_{1.15}Ni_{1/3}Co_{1/3}Mn_{1/3}O₂ as the main phase) were coated with lithium niobate in an air atmosphere and then fired in an air atmosphere to obtain positive electrode active material particles having a lithium niobate covering layer.

### (Formation of Positive Electrode Active Material Layer)

After adding the obtained positive electrode active material particles, polyvinylidene fluoride (PVdF), a sulfide solid electrolyte (LizS—P₂S₅ glass ceramic), vapor-deposited carbon fibers (VGCF) (pod of Showa Denko K.K.) and a dispersing medium to a polypropylene container, the components were stirred for 30 seconds with an ultrasonic disperser (UH-50 by SMT Co.). The container was then shaken for 3 minutes with a shaker (TTM-1 by Sibata Scientific Technology, Ltd.), and then further stirred for 30 seconds with an ultrasonic disperser. A positive electrode mixture slurry was thus obtained. The obtained positive electrode mixture was coated onto an aluminum (Al) foil as the substrate by the blade method using an applicator. After then allowing the coated film to naturally dry, it was dried for 30 minutes on a hot plate at 100° C. to form a positive electrode active material layer on the Al foil. The coating amount of the positive electrode mixture was adjusted for a thickness of 15 μm after densification at 4 t/cm.

### (Formation of Negative Electrode Active Material Layer)

After adding lithium titanate (LTO) particles as a negative electrode active material, polyvinylidene fluoride (PVdF), the same type of sulfide solid electrolyte as described above, and a dispersing medium into a polypropylene container, the components were stirred for 30 minutes with an ultrasonic disperser. A negative electrode mixture slurry was thus obtained. The obtained negative electrode mixture was coated onto one surface of a copper (Cu) foil as the negative electrode collector layer by the blade method using an applicator. After then allowing the coated film to naturally dry, it was dried for 30 minutes on a hot plate at 100° C. to form a negative electrode active material layer on the surface of the Cu foil. A negative electrode active material layer was formed on the other surface of the Cu foil in the same manner.

### (Formation of Solid Electrolyte Layer)

After adding heptane, butadiene rubber (BR), the same sulfide solid electrolyte as mentioned above and a dispersing medium into a polypropylene container, the components were stirred for 30 seconds with an ultrasonic disperser. The container was then shaken for 30 minutes with a shaker (TTM-1 by Sibata Scientific Technology, Ltd.), and then further stirred for 30 seconds with an ultrasonic disperser. A solid electrolyte material slurry was thus obtained. The obtained solid electrolyte material was coated onto an Al foil as the substrate by the blade method using an applicator. After then allowing the coated film to naturally dry, it was dried for 30 minutes on a hot plate at 100° C. to form a solid electrolyte layer on the Al foil.

(Fabrication of Positive Electrode Collector Layer with Recesses)

Acetylene black as a conductive aid, and an acrylic binder, were weighed out to 40:60 (volume ratio). Ethyl acetate was then added to prepare a carbon coating composition. The obtained composition was then coated onto the Al foil to a film thickness of 2 μm and the coated film was dried at 100° C. for 1 hour, to obtain an Al foil covered with a carbon layer. The obtained Al foil was cut as shown in FIG. 2. A positive electrode collector layer with recesses was thus obtained.

### (Fabrication of Electrode Stack)

The layers were attached together with both surfaces of the negative electrode active material layer formed on the negative electrode collector layer, in contact with the surface of the solid electrolyte layer, and the stack was pressed at 1.6 t/cm. The Al foil substrate was then released from the solid electrolyte layer. The layers were attached together with the surface of the positive electrode active material layer in contact with the surface of the solid electrolyte layer that had been exposed by release, and the stack was pressed at 1.6 t/cm. The Al foil substrate was then released from the positive electrode active material layer to obtain a stack. The obtained stack was pressed at 5 t/cm. After cutting so that the area of the stack was 50 mm×250 mm, insulation tape was attached to the side section of the electrode stack opposite the side section where the negative electrode collector layer was extended. A positive electrode collector layer with recesses was attached to the surface of the positive electrode active material layer at 140° C. under a load of 5 MPa. An electrode stack was thus obtained. Nine such electrode stacks were fabricated in the same manner. The obtained ten electrode stacks were layered and cut to a length of 40 mm in the y-direction. An electrode stack having positive electrode collector layers with 1 mm-deep recesses was thus obtained.

### (Placement of Anchoring Members)

An acrylate-based ultraviolet curing resin was bonded to the side sections of the electrode stack extending in the x-direction, to provide anchoring members. The coating amount and ultraviolet irradiation dose were controlled during this time to adjust the Young's modulus.

### (Fabrication of Battery)

Current collector terminals were welded to the positive electrode collector layer and negative electrode collector layer extending from the side sections of the obtained electrode stack running in the y-direction, and the electrode stack and parts of the current collector terminals were vacuum-sealed inside a laminate film. A battery was thus obtained for Example 1.

### <Evaluation>

### <Confirmation of Anchoring Member Peeling>

Any peeling of the anchoring members was visually confirmed during vacuum sealing in the step of fabricating the battery.

### <Measurement of Resistance Value>

The resistance of the battery was measured by a common method in the field of batteries.

### Examples 2 to 7

Batteries for Examples 2 to 7 were fabricated and evaluated in the same manner as Example 1, except that the Young's modulus and thicknesses of the anchoring members, and the lengths Lp, Lr and Ln, were changed as shown in Table 1.

### Example 8

A battery for Example 8 was fabricated and evaluated in the same manner as Example 1, except that for the positive electrode active material layer, the recesses were formed in the same manner at the locations where the recesses of the positive electrode collector layer were formed.

### Comparative Example 1

A battery for Comparative Example 1 was fabricated and evaluated in the same manner as Example 1, except that no recesses were formed in the positive electrode collector layer.

### <Results>

Table 1 shows the results for peeling of the anchoring members, and measurement of the resistance value. The resistance values are represented as relative values with the value of Comparative Example 1 as 1.00.

TABLE 1

| | Anchoring member | | | | | | | | | | | | |
|---|---|---|---|---|---|---|---|---|---|---|---|---|---|
| | Young's | Thick- | Recess | Lengths of positive electrode | | | | | | | | Results | |
| | Modulus | ness | depth | collector layer edges [mm] | | | | | | | | | Resis- |
| | [N/mm²] | [mm] | [mm] | Lc1 | Lb1 | La1 | Lb2 | La2 | Lb3 | Lc2 | Layer with recesses | Peeling | tance |
| Example 1 | 500 | 1.3 | 1 | 10 | 100 | 10 | 100 | 10 | — | — | Positive electrode collector layer | None | 1.00 |
| | | | | | | | | | | | alone | | |
| Example 2 | 500 | 1.6 | 1 | 10 | 80 | 10 | 30 | 10 | 80 | 10 | Positive electrode collector layer | None | 1.00 |
| | | | | | | | | | | | alone | | |
| Example 3 | 400 | 1.3 | 1 | 10 | 125 | 10 | 75 | 10 | — | — | Positive electrode collector layer | None | 1.00 |
| | | | | | | | | | | | alone | | |
| Example 4 | 400 | 1.6 | 1 | 10 | 100 | 10 | 100 | 10 | — | — | Positive electrode collector layer | None | 1.00 |
| | | | | | | | | | | | alone | | |
| Example 5 | 550 | 1.3 | 1 | 10 | 80 | 10 | 30 | 10 | 80 | 10 | Positive electrode collector layer | None | 1.00 |
| | | | | | | | | | | | alone | | |
| Example 6 | 500 | 1.3 | 3 | 30 | 100 | 10 | 100 | 10 | — | — | Positive electrode collector layer | None | 1.00 |
| | | | | | | | | | | | alone | | |
| Example 7 | 500 | 1.3 | 5 | 10 | 100 | 10 | 100 | 10 | — | — | Positive electrode collector layer | None | 1.01 |
| | | | | | | | | | | | alone | | |
| Example 8 | 500 | 1.3 | 3 | 10 | 100 | 10 | 100 | 10 | — | — | Positive electrode collector layer and | None | 1.01 |
| | | | | | | | | | | | positive electrode active material | | |
| | | | | | | | | | | | layer | | |
| Comp. | 500 | 1.3 | — | — | — | — | — | — | — | — | — | Yes | 1.00 |
| Example 1 | | | | | | | | | | | | | |

As shown in Table 1, no peeling of the anchoring members was observed in the batteries of the Examples which had recesses in the positive electrode collector layer.

The resistance values were low with the batteries of Examples 1 to 6 which had recesses only in the positive electrode collector layer and had recess depths of 1 to 3 mm.

### REFERENCE SIGNS LIST

100 Battery
10 Electrode stack
10a Recess
11 Positive electrode collector layer
12 Positive electrode active material layer
13 Electrolyte layer
14 Negative electrode active material layer
15 Negative electrode collector layer
20 Anchoring member
30 Laminate film
40 Current collector terminal

1. An electrode stack in which a positive electrode collector layer, a positive electrode active material layer, an electrolyte layer, a negative electrode active material layer and a negative electrode collector layer are stacked in that order,
wherein anchoring members containing the curable resin are disposed on side sections thereof, and
wherein among the layers of the electrode stack, the positive electrode collector layer and/or the negative electrode collector layer each have recesses on the sides where the anchoring members are disposed, with parts of the anchoring members intruding into the recesses.

2. The electrode stack according to claim 1, wherein only the positive electrode collector layer and/or the negative electrode collector layer has the recesses.

3. The electrode stack according to claim 2, wherein the positive electrode collector layer has the recesses.

4. The electrode stack according to claim 3, wherein the outermost positive electrode collector layer has the recesses.

5. The electrode stack according to claim 1, wherein the depth of the recesses is 1 mm or more and 3 mm or less.

6. A battery comprising:
one or more electrode stacks according to claim 1, and
a laminate film sealing the electrode stack.
